(19) United States
(12) Patent Application Publication
(10) Pub. No.: US 2006/0256559 A1
(43) Pub. Date: Nov. 16, 2006

(54) Integrated dazzling laser and acoustic disruptor device

(76) Inventor: Pete Bitar, Anderson, IN (US)

Correspondence Address: WOODARD, EMHARDT, MORIARTY, MCNETT & HENRY LLP, 111 MONUMENT CIRCLE, SUITE 3700, INDIANAPOLIS, IN, 46204-5137, US

(21) Appl. No.: 11/434,034

(22) Filed: May 15, 2006

Related U.S. Application Data
(60) Provisional application No. 60/681,440, filed on May 16, 2005.

(51) Int. Cl. G02B 27/20

(52) U.S. Cl. 362/259

(57) ABSTRACT

A method or device uses a dazzling laser light and an acoustic energy wave to non-lethally immobilize a person or animal. In some embodiments, the distance to the target is used to control the intensity of the dazzling laser light source striking the target subject and the acoustic energy output power.

### CROSS-REFERENCE TO RELATED APPLICATIONS

The present application claims priority to the previously filed provisional application U.S. Patent Application No. 60/681440 filed 16 May 2005, which is hereby incorporated by reference.

### TECHNICAL FIELD OF THE INVENTION

The present invention generally relates to non-lethal weapons and, more particularly, to an integrated dazzling laser and acoustic disruptor device.

### BACKGROUD OF THE INVENTION

There is an increasing desire to provide the military, police agencies, and civilians with non-lethal means of protection. Non-lethal force is force that is not inherently likely to kill or cause great bodily injury to a living target. In the past, police or the military called to a riot or other dangerous situations involving individuals were primarily limited to batons, pistols, rifles, automatic weapons or shotguns. To control the violence with minimal risk to human life, non-lethal or less-than-lethal means of disabling individuals or controlling riots have been developed. Illustratively, police agencies now employ non-lethal personal side arms, such as pepper sprays, tear gas and stun guns. Police agencies also employ “rubber” bullets. Some of these non-lethal weapons are available to private citizens.

As different parts of the body differ in vulnerability, and because people vary in weight and fitness, some “non-lethal” weapons can cause serious injury or death. Illustratively, the International Association of Chiefs of Police estimates that allergic reactions to pepper spray cause at least 113 deaths. Likewise, rubber bullets have been known to kill.

Thus, there exists a need for new and innovative non-lethal methods of providing protection to individuals, law enforcement and military personnel while ensuring the safety of the community and reducing the risk of serious injury or death to the intended target. In particular, there is a need for non-lethal weapons that do not risk permanent injury or death due to allergic reactions. There is a need for a non-lethal weapon that does not require close proximity to an intended target. There is a need for non-ballistic standoff weapons. Finally, there is also a need for a non-lethal weapon configuration to allow police to communicate with a potential target from a safe standoff distance.

### SUMMARY OF THE INVENTION

The present invention uses an ultrasonic acoustic disruptor circuit with a dazzling laser to provide a new non-lethal standoff weapon. The present invention uses various combinations of dazzling laser light and acoustic energy to cause pain and/or confusion in human and animal audio and visual receptors. In at least a one configuration, the device is designed to flash-blind the target. The device is also capable of conveying non-painful sonic messages into the heads of intended targets. The dazzling laser light and ultrasonic disruptor work in concert to temporarily blind, disorient and/or nauseate an intended target.

In some embodiments, a non-lethal method to immobilize a target includes emitting a burst of dazzling laser light and an acoustical energy wave directed towards a target. The target is immobilized by the impact of combined light intensity and sound intensity. In at least one embodiment, the device emitting the laser light and acoustical energy is a hand held device. In another embodiment, the acoustical energy burst is in the ultrasonic frequency band. In still another embodiment the laser light directed towards a target has an approximate wavelength of 532 nm.

In other embodiments, a handheld non-lethal immobilizer includes a dazzling laser light source having light expansion optics to produce a light intensity. The non-lethal immobilizer also includes an acoustical energy wave source having an audio energy output, wherein the ultrasonic wave source includes a speaker and a transducer. A controller is operatively coupled to a first switch, the dazzling light source and ultrasonic wave source. Then dazzling light source, ultrasonic wave source, first switch, and controller are received by a housing that is adapted to be handheld.

### BRIEF DESCRIPTION OF THE DRAWINGS

FIG. 1 is a schematic diagram of a first embodiment of the present invention.

FIG. 2 is a schematic diagram of an alternative embodiment of the present invention.

### DETAILED DESCRIPTION OF THE PREFERRED EMBODIMENTS

For the purposes of promoting an understanding of the principles of the invention, reference will now be made to the embodiment illustrated in the drawings and specific language will be used to describe the same. It will nevertheless be understood that no limitation of the scope of the invention is thereby intended, and alterations and modifications in the illustrated device, and further applications of the principles of the invention as illustrated therein are herein contemplated as would normally occur to one skilled in the art to which the invention relates.

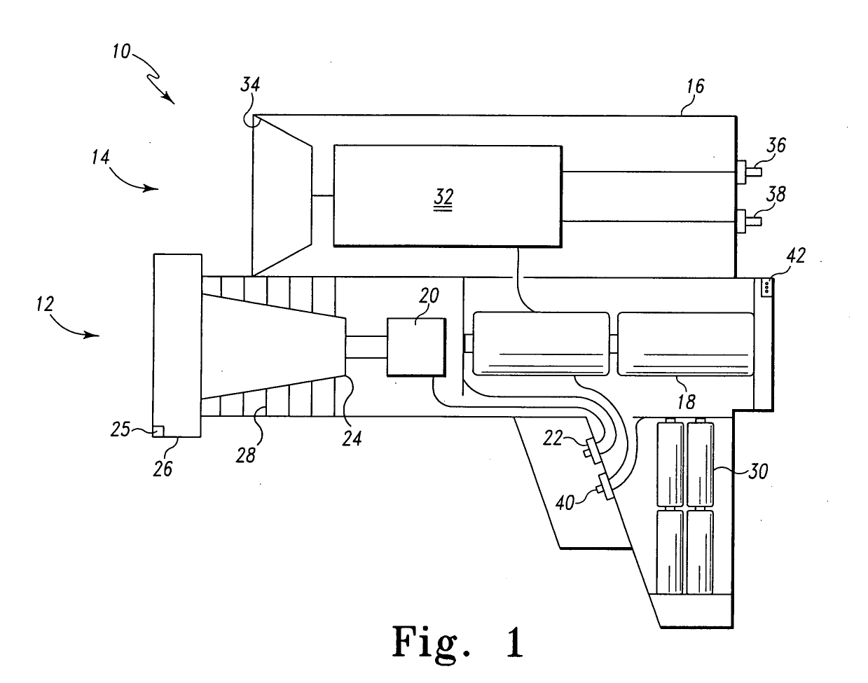

The present invention provides for a dazzling laser and an ultrasonic transducer integrated into a single device in order to provide two concurrent modes for non-lethally immobilizing a human or animal target. As illustrated in FIG. 1, at least one embodiment comprises a device 10 including a source 12 of dazzling laser light and an acoustic energy source 14 integrated into a single housing 16. In at least one embodiment, the acoustic energy is in the ultrasonic frequency band.

Housing 16 also contains a power supply 18, such as two C-cell batteries, for the dazzling laser 12, which is coupled to laser control circuitry 20. A firing switch 22 is located on the exterior surface of housing 16 and is coupled to control circuitry 20. Upon depressing firing switch 22, control circuitry 20 acts to couple the power supply 18 to a laser light source 24 of dazzling laser 12, thereby causing dazzling laser 12 to emit light having a desired characteristic. The laser light source 24 may be a laser diode, an array of laser diodes or other lasers as known in the art. The laser beam is optionally routed through appropriate beam expansion optics 26. As a non-limiting example, the laser beam passes through at least one lens or a beam expander to create a larger spot size. Alternatively, the beam expansion optics can be incorporated into laser light source 24. In other embodiments, the laser light is spread by rasterizing laser light source 24 to regulate the average power of light falling upon a particular target region. The laser diode also may be cooled by a heat sink 28.

Additionally, the housing 16 also contains a power supply 30, such as four AA-cell batteries, for the ultrasonic transducer driver circuitry 32, which is coupled to a speaker 34. The ultrasonic transducer driver circuitry 32 comprises a transducer and associated logic and programming to produce an ultrasonic sound burst. Moreover, the ultrasonic transducer driver circuitry 32 may provide voice messages to a target by modulating the ultrasonic signal according to a predetermined modulation pattern or using speech patterns received by device 10. The ultrasonic signal is detected though the bone conduction process. Human listeners may perceive speech from a voice-modulated ultrasonic carrier presented via a bone-conduction stimulator.

It will be understood that various alternative modes of operation may be implemented. Illustratively, a mode selector switch may be used to select between different messages to be transmitted in the direction of the target by modulating the ultrasonic energy burst. Furthermore, the system can additionally be used to convey messages through the ultrasonic beam; telling a would-be attacker to “surrender” or “stand back.” In at least one embodiment, pre-recorded messages are selected by the user. In other embodiments, a user audio input 42, illustratively a microphone, operatively coupled to the controller 120 to allow a user to pre-record a message or input a message in real time. In alternative embodiments, the user input 42 is an audio jack for receiving audio inputs. It will be understood that the audio jack may be adapted to receive either analog or digitally formatted audio inputs.

It will be understood by those skilled in the art that in some embodiments, power sources 18 and 30 may be integrated into a single power source. A first potentiometer 36 controls the frequency sweep of the ultrasonic transducer. A second potentiometer 38 controls a pulse rate adjustment of the ultrasonic transducer. It will be understood that additional user controls are envisioned to allow a user to control the nature and character of the dazzling laser light source 12 and acoustic energy wave. As a non-limiting example, an additional switch or potentiometer may be included to allow a user to control the pulse rate of the dazzling laser light. Depending upon the user setting, the dazzling light source 12 provides bursts of laser light at a user selected frequency. Likewise, although a potentiometer is provided as an example, it will be understood that other continuous or discrete control inputs are envisioned.

A firing switch 40 is located on the exterior surface of housing 16 and is coupled to ultrasonic transducer driver circuitry 32. Upon depressing firing switch 40, driver circuitry 32 acts to transform power from power supply 30 into an ultrasonic energy burst that is coupled to speaker 34. When received by a human or animal target, the light from the dazzling laser temporary blinds the intended target. The acoustic energy emitted by the ultrasonic transducer affects the target's internal sense of equilibrium, which can cause the target to become disoriented and/or nauseated.

Dazzling laser 12 may be any source of dazzling light, such as the SaberShot Photonic Disruptor™ (sold by Xtreme Alternative Defense Systems, P.O. Box 205, Anderson, Ind. 46016), which is a 532 nm (green) high intensity laser light source. Dazzling laser 12 is used to temporarily flash-blind and disorient an aggressor. Temporarily taking away the target's ability to see lowers the risk associated with subduing the target. Alternatively, temporarily disabling the target can buy time for additional friendly forces to arrive or to take further action in either law-enforcement or military operations.

Ultrasonic transducer 32 may be any source of acoustic energy. One non-limiting example is the “PPP-series” transducers available from Information Unlimited Corp. (P.O. Box 716, Amherst, N.J. 03031-0716), which is designed to create a highly directional ultrasonic energy burst that can be aimed at the target. A tiny organ in the inner ear called the saccule, which is normally associated with balance control, is the hearing organ for ultrasonic sound. The ultrasonic energy emitted by ultrasonic transducer 14 can cause extreme disorientation and can affect the cilia of the inner ear of humans and other animals. As a result, the target's sense of equilibrium diminishes. The loss of equilibrium causes the target to fall or to retreat from a standing position.

Some people, however, have poor natural equilibrium, and therefore use their eyesight to orient their balance. The device 10 takes away both senses and capabilities that maintain a person's ability to stand and walk with balance. As a result, the non-permanent and non-lethal effects provide an effective means of subduing a target in many combat and law enforcement scenarios.

Laser 12 fires a beam of light that is designed to not permanently harm the eye, maintaining in one embodiment a maximum light density of approximately or about 26 milliwatts per square centimeter in the impact area. However, in other embodiments the laser intensity can range between two to approximately 26 milliwatts per square centimeter. In still other embodiments, the intensity is adjustable. Illustratively, in some embodiments the intensity increases based upon the time that the laser is turned on. Illustratively, the initial power density can be set at an intermediate level of 10 mW per square centimeter; yet, after a period of time passes, the intensity increases to 20 mW per square centimeter. It will be appreciated by those skilled in the art that the initial power level can be any power level less than the maximum power density. Similarly, the final power density may be a power density less than the initial power density or more than the initial power density depending upon the environmental conditions, reaction of the target or passage of time. Solid-state lasers or diode pumped lasers are well suited for use as laser 12 because of their compact size and low power requirements. In some embodiments, a rangefinder feature is incorporated to provide a distance measurement to the target. Based upon the dispersion characteristics of lens 26, the power output of laser light source 24 is adjusted to maintain a desired light intensity on the target. In at least one alternative embodiment, laser light source 24 initially projects a low intensity laser light pulse onto the target. A sensor 25 operably coupled to laser control circuitry 20 is incorporated into dazzling laser assembly 12. The laser control circuitry 20 calculates the round-trip time of the laser light pulse reflecting off the target to determine the distance to the target. In some embodiments, sensor 25 is a light sensor for receiving the laser light pulse from laser light source 24. In alternative embodiments, sensor 25 is a rangefinder. Based upon the dispersion characteristics of lens 26 and the calculated distance to target, laser control 20 adjusts the intensity of the laser light emitted from laser light source 24. It will be appreciated by those skilled in the art that as an alternative embodiment a separate rangefinder can be included in device 10.

Ultrasonic transducer 14 fires a burst of ultrasonic energy (non-audible sound, for example at 40 kHz) in excess of 100 decibels. In some embodiments, the distance to the target is used in combination with the dispersal characteristics of sound for a given environment to adjust the level of ultrasonic energy directed at the target.

The target is affected by both the intense, flash-blinding light from laser 12, as well as the high-frequency/sonic noise that transducer 34 conveys to the target. The takedown effect is effective even after the target has closed its eyes. Device 10 has psychological warfare applications in addition to immediate effect-based applications. This can allow soldiers or law-enforcement officers, or even a crime victim additional time to choose between various courses of action.

Device 10 is preferably hand-held, the size of a pistol or flashlight, or can even be made larger to defend a larger area. In such cases, the device is vehicle or building mounted.

In some embodiments, dazzling laser 12 and ultrasonic transducer 34 operate independently, but may optionally be activated by a single trigger and/or a single battery source (not shown). Optionally, device 10 can be provided with dual triggers as shown in FIG. 1, allowing the user to fire either dazzling laser 12 or ultrasonic transducer 14 alone, or if desired in combination for maximum effect. For example, laser 12 can be used as a signaling “flare” or target marker by itself, whereas ultrasonic transducer 14 can be fired without the laser to conceal a location of the user, with at least some effect on targets.

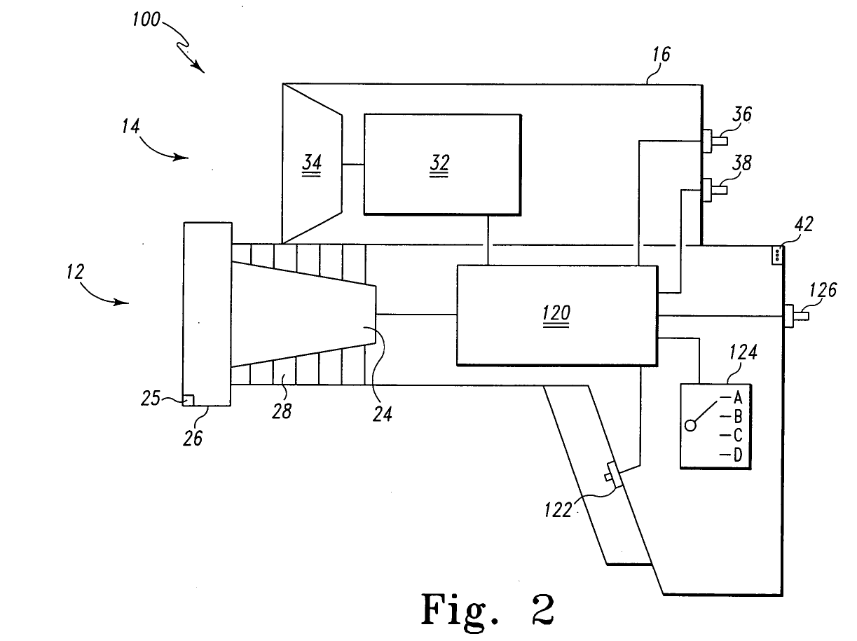

An alternative embodiment of device 10 is illustrated in FIG. 2 as device 100. It will be appreciated that like-numbered elements correspond and function substantially similar to those elements described above in reference to device 10. Integrated controller 120 operably couples to laser light source 24, ultrasonic transducer driver circuitry 32, frequency control 36, rate control 38, trigger switch 122, mode selector 124, and safety 126. In some alternative embodiments, the ultrasonic transducer driver circuitry 32 is subsumed within integrated controller 120. It will be appreciated that integrated controller 120 incorporates at least a portion of the functions and operations of laser control circuitry 20 and ultrasonic transducer driver circuit 34. It will also be appreciated that trigger switch 120 incorporates the activation function of switches 22 and 40 dependent upon the state of mode selector 124 and safety switch 126.

In still other embodiments, trigger switch 122 can incorporate either a discrete-ized or linear position indicator to initiate different control functions. Illustratively, at a first trigger 122 position, device 100 produces a first power density of illumination and at a fully depressed trigger 122 position device 100 produces a maximum allowable power density. In an alternative embodiment, device 100 illuminates an area without depressing trigger 122. However, upon depressing trigger 122, the illumination power density increases. It will be understood that the power density output of the laser can be related to the degree of trigger depression. Likewise, the amplification of the acoustic signal can vary with the degree of trigger depression. As a non-limiting example, at a first power level, the acoustic signal is at a level necessary to communicate information; however, at a second or other power level the acoustic signal is at a level that induces pain in the target's auditory sensory system.

Mode selector 124 provides the user of device 100 the ability to select between different modes of operation. As illustrated, selector switch 124 has four states, A, B, C, and D, corresponding to different modes of operation. As a first non-limiting example, the states of selector switch 124, A, B, C, and D, correspond to the functions “Flashlight Illumination,” “Acoustic Burst,” “Dazzling Laser Burst Only,” and “Acoustic and Dazzling Laser Burst,” respectively.

The “Flashlight Illumination” mode of operation causes device 100 to project a low intensity level laser light at the directed target area when trigger switch 122 is actuated. The “Acoustic Burst” mode of operation causes device 100 to emit an acoustic burst of energy when trigger 122 is actuated. The “Dazzling Laser Burst Only” mode of operation causes device 100 to emit a high intensity burst of laser light capable of temporarily disabling the target when trigger 122 is actuated. Finally, the “Acoustic and Dazzling Laser Burst” mode of operation causes device 100 to emit both an acoustic energy burst and a high intensity burst of laser light capable of temporarily disabling the target when trigger 122 is actuated. Safety switch 126 allows the user to place device 100 into a “safe mode,” which disables at least a portion of the operation of device 100. As non-limiting examples of potential “safe mode” functionality, setting the safety switch 126 into the “safe” position may either disable device 100 completely or only allow non-pain inducing functions.

While the invention has been illustrated and described in detail in the drawings and foregoing description, the same is to be considered as illustrative and not restrictive in character, it being understood that only the preferred embodiment has been shown and described and that all changes and modifications that come within the spirit of the invention are desired to be protected.

What is claimed is:

1. A method for non-lethal immobilization of a target comprising the steps of:
emitting a dazzling laser light having a laser light intensity toward said target; and
emitting an acoustical energy wave having a sound intensity toward said target;
wherein said laser light and said acoustical energy impinge upon said target to temporarily immobilize said target.

2. The method of claim 1, further comprising the step of:
determining a distance to said target; and
using said distance to said target to control said laser light intensity.

3. The method of claim 2, further comprising the step of:
using said distance to said target to control said sound intensity.

4. The method of claim 1, wherein said device is a handheld device.

5. The method of claim 1, wherein said acoustical energy wave comprises an ultrasonic component.

6. The method of claim 1, wherein said dazzling laser light comprises wavelengths within a green spectrum of light.

7. The method of claim 6, wherein said dazzling laser light comprises wavelengths of about 532 nm.

8. The method of claim 1, wherein said laser light intensity at said target is not substantially more than about 26 milliwatts per square centimeter.

9. The method of claim 1, wherein said sound intensity is not less than about 100 decibels.

10. The method of claim 1, wherein said dazzling laser light and said acoustical energy wave are simultaneously directed at said target.

11. The method of claim 1, further comprising the step of:
pulsing said dazzling laser light.

12. The method of claim 1, further comprising the step of:
pulsing said acoustical wave energy.

13. The method of claim 1, further comprising the step of:
selecting by a user one of a plurality of modes of operation.

14. The method of claim 13, wherein in a first mode of operation the dazzling light and acoustical energy wave are emitted simultaneously.

15. The method of claim 13, further comprising the step of:
selecting by a user a frequency of said acoustic energy wave.

16. The method of claim 1, further comprising the step of:
controlling said laser light intensity to provide an illumination less than that required to temporarily immobilize said target in order to illuminate an area approximately about a target area.

17. The method of claim 1, further comprising the step of:
modulating said acoustical energy wave to communicate a verbal command to said target.

18. The method of claim 17, further the comprising the step of:
receiving said verbal command from an external input.

19. The method of claim 17, wherein said acoustical energy wave comprises an ultrasonic component.

20. A non-lethal immobilizer comprising:
a housing adapted to be handheld;
a dazzling laser light source having a light intensity and disposed within said housing;
an acoustical energy wave source having an audio energy output and disposed within said housing; and
a switch disposed within said housing and operatively coupled to said dazzling laser light source and said ultrasonic wave source;
wherein said dazzling laser light source and said acoustical energy wave source can be activated simultaneously by said switch.

21. The non-lethal immobilizer of claim 20, where said dazzling laser light source includes a light expansion optics.

22. The non-lethal immobilizer of claim 20, wherein said ultrasonic wave source include a speaker and a transducer.

23. The non-lethal immobilizer of claim 20, further comprising a controller disposed within said housing and operably coupled to said dazzling light source, said ultrasonic wave source, and said switch.

24. The non-lethal immobilizer of claim 23, further comprising:
a sensor operably coupled to said controller, wherein said sensor is adapted to provide to said controller an indication of a distance to a target and said controller is operative to adjust said light intensity based upon said distance to said target.

25. The non-lethal immobilizer of claim 23, further comprising:
a rangefinder operably coupled to said controller, wherein said range finder provides to said controller an indication of distance to a target and said controller is operative to adjust said audio energy output based upon said distance to said target.

26. The non-lethal immobilizer of claim 23, further comprising:
a mode selector operably coupled to said controller, wherein said mode selector is adapted to provide at least one operational configuration input to said controller.

27. The non-lethal immobilizer of claim 26, wherein said at least one operational configuration includes a dazzling laser light only mode.

28. In non-lethal immobilizer of claim 26, wherein said at least one operational configuration includes an acoustical only mode.

29. The non-lethal immobilizer of claim 26, wherein said at least one operational configuration includes a dual mode, wherein said non-lethal immobilizer is adapted to emit a combination of dazzling light and ultrasonic wave simultaneously.

30. The non-lethal immobilizer of claim 26, wherein said at least one operational configuration includes a safety mode.

31. The non-lethal immobilizer of claim 26, wherein said at least one operational configuration includes an illumination mode.

32. The non-lethal immobilizer of claim 26, wherein said at least one operational configuration includes a message mode.

33. The non-lethal immobilizer of claim 32, wherein said one operational configuration includes a warning mode.

34. The non-lethal immobilizer of claim 33, wherein said warning mode includes an audible warning mode.

35. The non-lethal immobilizer of claim 33, wherein said warning mode includes a visible warning mode.

36. The non-lethal immobilizer of claim 23, further comprising:
a pulse rate control operable to provide at least one user selectable pulse rate state to said controller.

37. The non-lethal immobilizer of claim 23, further comprising:
a frequency control operative to provide at least one user selectable frequency state to said controller.

38. The non-lethal immobilizer of claim 23, wherein said dazzling laser source produces wavelength of light within a green spectrum of light.

39. The non-lethal immobilizer of claim 23, wherein said dazzling laser light comprises a wavelength of about 532 nm.

40. The non-lethal immobilizer of claim 23, further comprising a light sensor coupled to said controller;
wherein said light sensor provides an indication of the distance to said target; and
wherein said controller uses said indication of distance to adjust said light intensity falling upon said target.

41. The non-lethal immobilizer of claim 40, wherein said controller uses said indication of distance to adjust said audio energy output.

42. The method of claim 40, wherein said laser light has intensity at said target is not more than about 26 milliwatts per centimeter.

43. The method of claim 23, wherein said light expansion optics include a rasterizer adapted to raster scan said laser light to produce a desired average power density of dazzling light falling upon said target.
